(19) United States
(12) Patent Application Publication
(10) Pub. No.: US 2012/0081730 A1
(43) Pub. Date: Apr. 5, 2012

(54) IMAGE PROCESSING APPARATUS, CONTROL METHOD THEREOF AND COMPUTER PROGRAM

(75) Inventor: Mario Ito, Kawasaki-shi (JP)

(73) Assignee: CANON KABUSHIKI KAISHA, Tokyo (JP)

(21) Appl. No.: 13/218,214

(22) Filed: Aug. 25, 2011

(30) Foreign Application Priority Data
Sep. 30, 2010 (JP) 2010-222432

(51) Int. Cl. G06K 15/02

(52) U.S. Cl. 358/1.13

(57) ABSTRACT

The present invention provides an image processing apparatus that has a Web browser function and is connectable to a server having a Web server function. The image processing apparatus transmits a request to the server, based on a user operation input via a display screen displayed on a browser. In the case where a response from the server to the request has been received normally, the image processing apparatus displays a screen on the browser in accordance with the contents of the response, and in the case where the response has not been received normally, the image processing apparatus displays the execution status of the current job, using information held by the image processing apparatus.

### BACKGROUND OF THE INVENTION

1. Field of the Invention

The present invention relates to an image processing apparatus, a control method thereof, and a computer program.

2. Description of the Related Art

Connecting an information processing apparatus such as PC to a Web server on a network, and displaying content such as an operation screen provided by the Web server on a Web browser provided in the information processing apparatus is known. There are now also MFPs (Multi Function Peripherals), which are image processing apparatuses provided with a scanner, a printer and so on, that are provided with a Web browser such as mentioned above. Such MFPs display content provided by a Web server on their own Web browser, and accept various instructions from the user.

Further, technology for using the functions provided in an MFP via an operation screen displayed on the Web browser has also been proposed. In this case, the Web server provides an operation screen on which instructions may be input to use the functions provided in the MFP. That is, the user of the MFP inputs an instruction to the MFP via the operation screen displayed on the Web browser. The input instruction is then transmit to the Web server as a request by the Web browser of the MFP, thereby notifying the Web server. The Web server, having received this notification, requests the MFP to execute various types of processing in accordance with the contents of the instruction input by the user. Further, the MFP, having received this request, executes the requested processing. All of the operation screens for operating the MFP thereby need not be held in the MFP, and operation screens can also be easily changed on the Web server.

Also, Japanese Patent Laid-Open No. 2007-042098 proposes a technique for an MFP that has received a request from a Web server to notify an arbitrary server in the case where an error or the like occurs while the MFP is executing the requested processing. The server accepts the notification from the MFP, and returns a URL for notifying the user that an error has occurred to the MFP as a response. Subsequently, the MFP makes an inquiry from the Web browser to the Web server based on the response from the server, acquires content such as an appropriate error message, and displays the acquired content on a screen. The display content and display screen can thereby be controlled with the Web server, even with regard to an error message or the like for an error that has occurred in the MFP.

However, the following problem exists with the conventional technology. In the above conventional technology, the MFP initially needs to transmit a state change notification to the server and wait for a response from the server in order to display the error message. However, state notification from the MFP to the server and reception of the response from the server cannot be performed in the case where the network is down or an abnormality occurs in the server. Accordingly, the user may not be able to find out about the occurrence of a network failure or the execution status of a job.

### SUMMARY OF THE INVENTION

The present invention enables realization of an image processing apparatus that executes processing in cooperation with a connected server, and that, even in the case where the connection with the server is down or an abnormality occurs in the server, informs a user of this situation and the job execution status, and a control method thereof.

One aspect of the present invention provides an image processing apparatus that has a Web browser function and is connectable to a server having a Web server function, comprising: a transmission unit that transmits a request to the server, based on a user operation input via a display screen displayed on a browser; a determination unit that determines whether a response from the server to the request has been received normally; and a display control unit that displays a screen on the browser in accordance with a content of the response in a case where the response has been received normally, and displays an execution status of a current job using information held by the image processing apparatus in a case where the response has not been received normally.

Another aspect of the present invention provides a control method of an image processing apparatus that has a Web browser function and is connectable to a server having a Web server function, comprising: transmitting a request to the server, based on a user operation input via a display screen displayed on a browser; determining whether a response from the server to the request has been received normally; and displaying a screen on the browser in accordance with a content of the response in a case where the response has been received normally, and displaying an execution status of a current job using information held by the image processing apparatus in a case where the response has not been received normally.

Further features of the present invention will be apparent from the following description of exemplary embodiments with reference to the attached drawings.

### BRIEF DESCRIPTION OF THE DRAWINGS

FIG. 1 is a diagram showing an example configuration of an image processing system according to a first embodiment.

FIG. 2 is a block diagram showing an example hardware configuration of an image processing apparatus according to the first embodiment

FIG. 3 is a block diagram showing an example hardware configuration of a server according to the first embodiment.

FIG. 4A is a block diagram showing example software configurations of the image processing apparatus and a Web server according to the first embodiment.

FIG. 4B is a block diagram showing example software configurations of the image processing apparatus and the Web server according to a second embodiment.

FIG. 4C is a block diagram showing example software configurations of the image processing apparatus and the Web server according to a third embodiment.

FIG. 5 is a sequence chart showing a series of processes of the image processing system according to the first embodiment.

FIG. 6 is a flowchart showing a processing procedure of the Web browser according to the first embodiment.

FIG. 7 is a flowchart showing a processing procedure of a service provider according to the second embodiment.

FIG. 8 is a flowchart showing a processing procedure of the service provider according to the third embodiment.

### DESCRIPTION OF THE EMBODIMENTS

Embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

### First Embodiment

### Configuration of Image Processing System

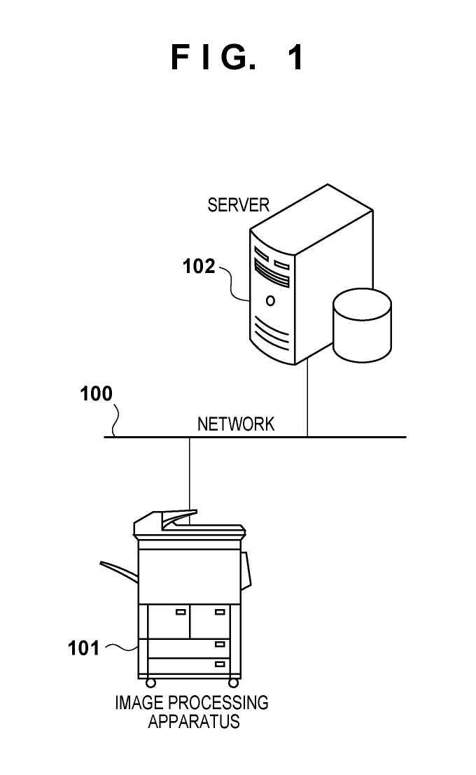

Hereinafter, a first embodiment of the present invention will be described with reference to FIG. 1 to FIG. 6. Firstly, an image processing system according to the present embodiment will be described with reference to FIG. 1. This image processing system includes an image processing apparatus 101 and a server 102 that are connected via a network 100. The network 100 is a basis for communication between devices, and may be an intranet, the Internet or another network system. The image processing apparatus 101, if provided with a Web browser function, may be an MFP (Multi Function Peripheral) or the like. Also, the server 102 has a Web server function for delivering Web content via a network, and returns Web content according to a request from the image processing apparatus 101.

Hardware Configuration of Image Processing Apparatus

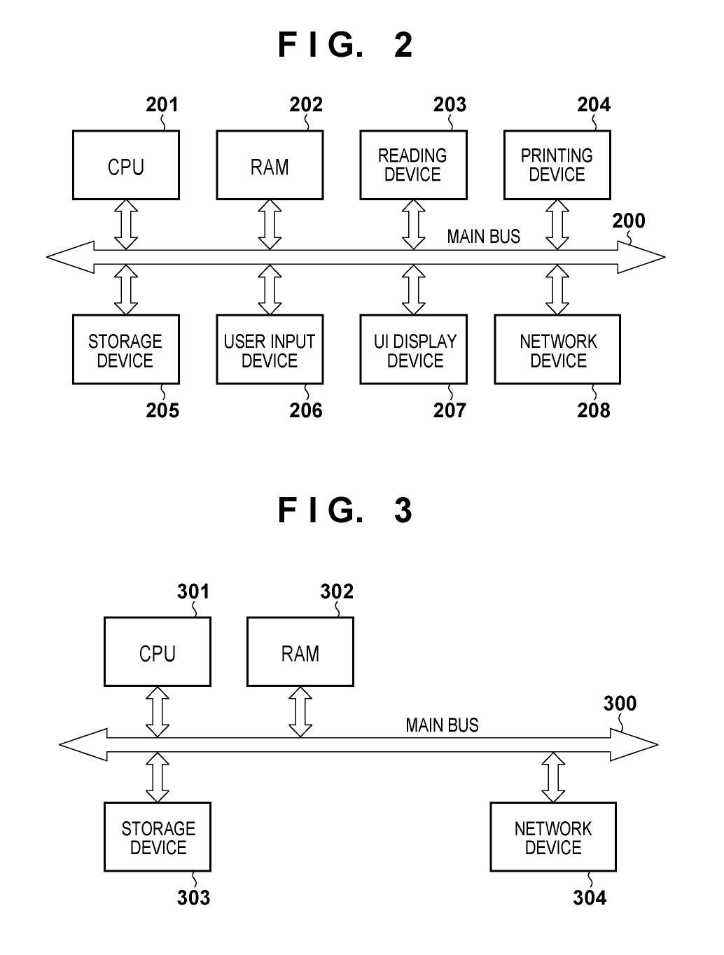

Next, an example configuration of the image processing apparatus 101 in the present embodiment will be described with reference to FIG. 2. The image processing apparatus 101 is provided with a CPU 201, a RAM 202, a reading device 203, a printing device 204, a storage device 205, a user input device 206, a UI display device 207, and a network device 208. The CPU 201 performs overall control of the image processing apparatus 101. The RAM 202 provides a work area for the CPU 201.

The reading device 203 reads an image from an original document placed on the image processing apparatus 101 and outputs image data. The printing device 204 prints an image onto printing material in accordance with image data output from the reading device 203 or image data transmit from an external apparatus connected to the image processing apparatus 101. The storage device 205 is an HDD, NVRAM or the like on which a computer program and various setting information relating to the present invention are stored. The user input device 206 is a user interface for the user to input a command. The UI display device 207 performs screen display using data held by the image processing apparatus 101 or data acquired from the server 102. The network device 208 controls communication with an external apparatus and a network. These components are communicably connected to each other by a main bus 200.

Note that, in the present embodiment, the CPU 201 performs overall control of the RAM 202, the reading device 203, the printing device 204, the storage device 205, the user input device 206, the UI display device 207 and the network device 208 via the main bus 200 unless it is specifically stated otherwise. Also, the UI display device 207 may be combined with the user input device 206 like a touch panel display.

Hardware Configuration of Server

Next, an example configuration of the server 102 in the present embodiment will be described with reference to FIG. 3. The server 102 is constituted by a CPU 301, a RAM 302, a storage device 303, and a network device 304. The CPU 301 performs overall control of the server 102. The RAM 302 provides a work area for the CPU 301. The storage device 303 stores a computer program and setting information relating to the present invention. The network device 304 controls communication with an external apparatus and a network. These components are communicably connected to each other by a main bus 300. Note that, in the present embodiment, the CPU 301 performs overall control of the RAM 302, the storage device 303, and network device 304 via the main bus 300 unless it is specifically stated otherwise.

Software Configuration of Image Processing System

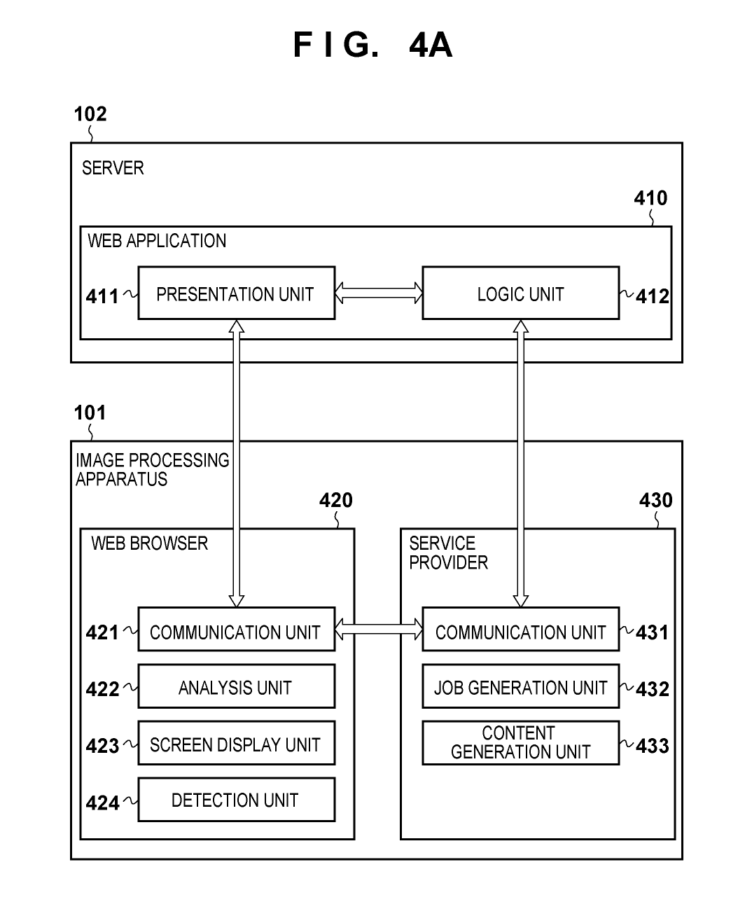

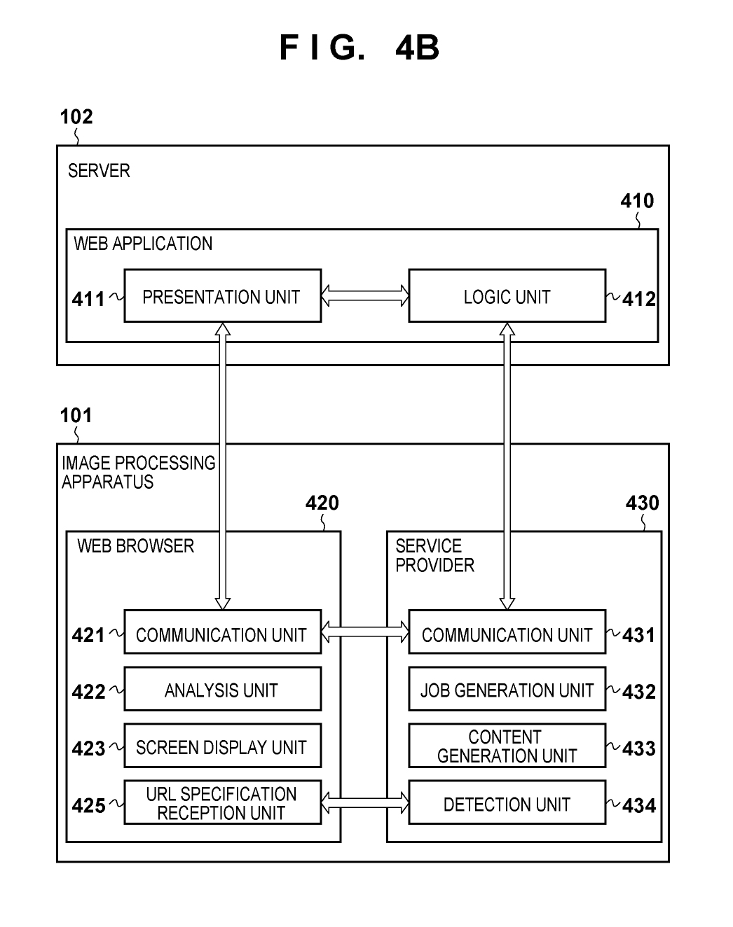

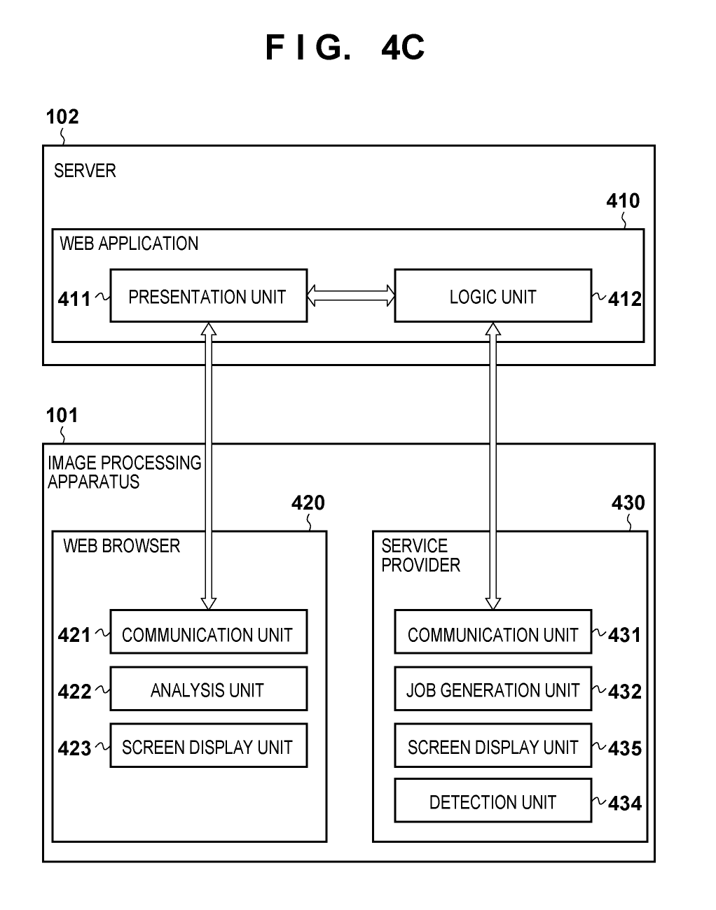

Next, an example software configuration of the entire image processing system in the first embodiment will be described with reference to FIG. 4A. The functional units shown in FIG. 4A are realized by the CPU 201 and the CPU 301 respectively provided in the image processing apparatus 101 and the server 102 executing a control program. Note that while the software configuration of the image processing system will now be described, these functional blocks may be realized by hardware or a combination of hardware and software.

The image processing apparatus 101 is provided with a Web browser 420 for realizing a Web browser function, and a service provider 430 that controls job execution performed via the above Web browser function. The Web browser 420 and the service provider 430 are respectively realized by the CPU 201 included in the image processing apparatus 101 executing a control program. Note that the Web browser 420 is not limited to displaying content of the server 102. Similarly, the server 102 is not limited to being a Web server that transmits and receives requests/responses in accordance with the HTTP protocol. Accordingly, the Web browser 420 need only have the function of acquiring content by communicating with an arbitrary server, and displaying acquired content on a screen. Here, content indicates information relating to a display screen that the image processing apparatus 101 displays on the UI display device 207.

The Web browser 420 is provided with a communication unit 421, an analysis unit 422, a screen display unit 423, and a detection unit 424. The communication unit 421 communicates with a presentation unit 411 in a Web application 410 of the server 102 according to the HTTP protocol. More specifically, the communication unit 421 transmits information input via the operation screen displayed by the Web browser 420 as a request to the after-mentioned Web application 410. Also, the communication unit 421 receives a response (processing result) transmit from the Web application 410. Similarly, in the case where a state change is detected by an after-mentioned detection unit 424, the communication unit 421 sends a request to a communication unit 431 of the service provider 430, and receives a response transmit from the communication unit 431.

The analysis unit 422 analyzes the response received from the Web application 410. HTML data that is a description indicating the contents of an operation screen to be displayed on the Web browser 420 is included in the response. The screen display unit 423 displays the operation screen on the UI display device 207, based on the result of analyzing the HTML data (display information) by the analysis unit 422. The detection unit 424 monitors whether communication is completed normally, and, in the case where communication has not been performed normally, instructs the communication unit 421 to communicate with the communication unit 431.

The service provider 430 is provided with the communication unit 431, a job generation unit 432, and a content generation unit 433. The communication unit 431 accepts a processing request from a logic unit 412 in the Web application 410. Also, in the case where a request is received from the communication unit 421 of the image processing apparatus 101, the communication unit 431 returns content information (HTML data) generated by the after-mentioned content generation unit 433 as a response. The job generation unit 432 receives the processing request that the communication unit 431 accepted, and generates and executes a job for executing the requested processing. In the case where the communication unit 431 receives a request from the communication unit 421 of the image processing apparatus 101, the content generation unit 433 generates content information (HTML data) for the Web browser 420 to display a screen. Also, rather than generating content dynamically, the content generation unit 433 may reference and use content prestored in the storage device 205.

Sequence

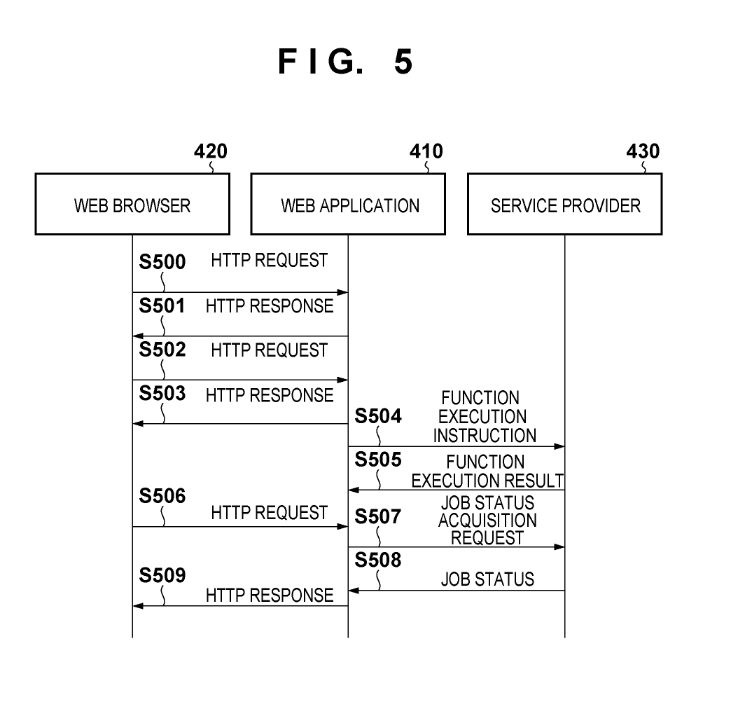

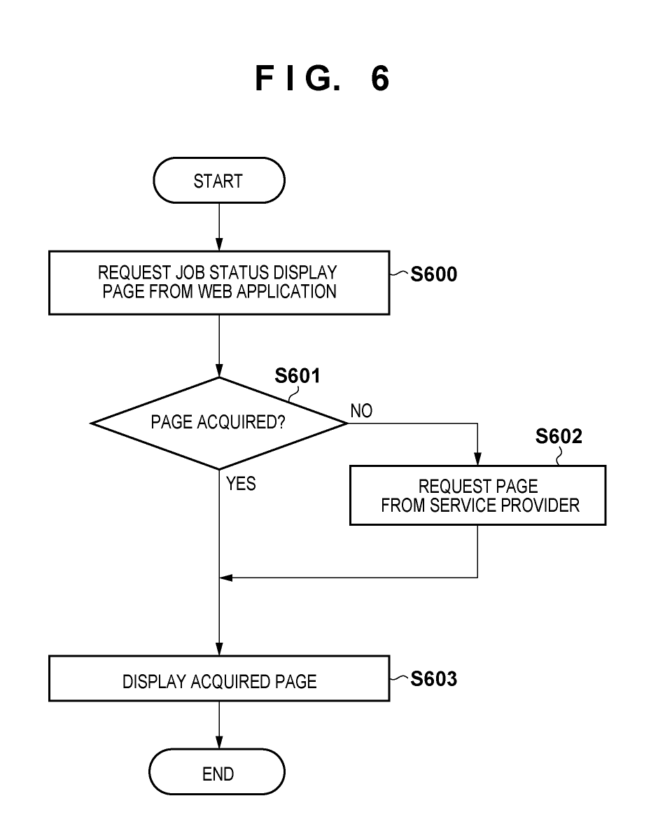

Next, the series of processes of the image processing system in the present embodiment will be described with reference to FIG. 5. This sequence is started as a result of the Web browser 420 of the image processing apparatus 101 being launched by a user. Firstly, in S500, the Web browser 420 sends an HTTP request to the Web application 410 of the server 102. In S501, the Web application 410, having received the request, returns HTML content (display information) for a screen to be displayed by the Web browser 420. For example, in the case where the request is for a scan settings screen, the Web application 410 responds by sending HTML for displaying a scan settings screen.

When the user has performed an operation on content displayed on the browser, the Web browser 420, in S502, transmits an HTTP request to the Web application 410 in accordance with the user operation, and requests function execution by the service provider 430. Here, the Web application 410 judges that scan execution is requested if the user presses a scan execution button, for example. In S503, the Web application 410 responds by sending HTML content for screen display to the Web browser 420. The content transmit as a response here is HTML content informing the user that processing is currently being executed.

In S504, the Web application 410 instructs the service provider 430 to perform function execution. For example, scan execution is instructed, and scanning is executed by the image processing apparatus 101. In S505, the service provider 430 responds by sending the function execution result to the Web application 410.

In S506, the Web browser 420 transmits an HTTP request to the Web application 410 at prescribed intervals. When a request is received from the Web browser 420, the Web application 410 sends a job status acquisition request to the service provider 430 in S507. Subsequently, in S508, the service provider 430 responds by sending a job status to the Web application 410. When the job status is acquired, the Web application 410, in S509, responds by sending HTML content informing the user of the job status to the Web browser. For example, in the case of scanning being executed, the service provider 430, in S508, responds by sending a job status indicating that the scan job is currently being executed or has ended to the Web application 410. As a result of the Web application 410 responding by sending content including the result to the browser 420, the user is able to find out the execution status of the scan job. Note that the HTTP request of S506 is repeatedly sent at prescribed intervals until the job being executed is ended.

Processing Procedure of Web Browser

Next, the processing procedure of the Web browser 420 in the present embodiment will be described with reference to FIG. 6. Note that the processing described hereinafter is realized by the CPU 201 executing a computer program read out from the storage device 205.

In S600, the communication unit 421 requests HTML content displaying the execution status of the job being processed in the image processing apparatus 101 from the presentation unit 411 of the Web application 410, and receives the content. In S601, the detection unit 424 determines whether the content has been received normally at S600. Here, the processing advances to S602 in the case where the network is down or where the content has not been received normally due to an abnormality in the server 102. Specifically, the detection unit 424 determines that the above content has not been received normally, in the case where a response to a request for HTML content is not received before a prescribed time elapses after the HTML content is requested, or where the response includes error information. On the other hand, the processing advances to S603 in the case where the content has been received normally. Note that the detection unit 424 may be implemented as Java (registered trademark) Script included in HTML content.

In S602, the communication unit 421 requests HTML content displaying the execution status of the job being processed in the image processing apparatus 101 from the communication unit 431 of the service provider 430, and receives content. Note that processing by the communication unit 421 may, similarly to S601, be implemented as Java (registered trademark) Script included in HTML content. Content received at this time indicates the status of the job currently being executed by the service provider 430, with error-related information and the progress status of the job being described. Also, processing for again requesting content from the Web application 410 may be described in this content. This processing is not limited to HTML, and may be provided by Java (registered trademark) Script or Flash content. Thereafter, in S603, the analysis unit 422 analyzes the HTML content received at S601 or S602, and displays the analysis result using the screen display unit 423.

As described above, with the image processing system in the first embodiment, the Web browser 420 requests HTML content displaying the execution status of a job directly from the service provider 430 in the case where the Web browser 420 detects an abnormality in the network, and displays the result. Thus, with the image processing apparatus in the first embodiment, the user can be informed of the status of a job currently being executed even in the case where an abnormality occurs in the network while a job using a Web application is currently being executed.

### Second Embodiment

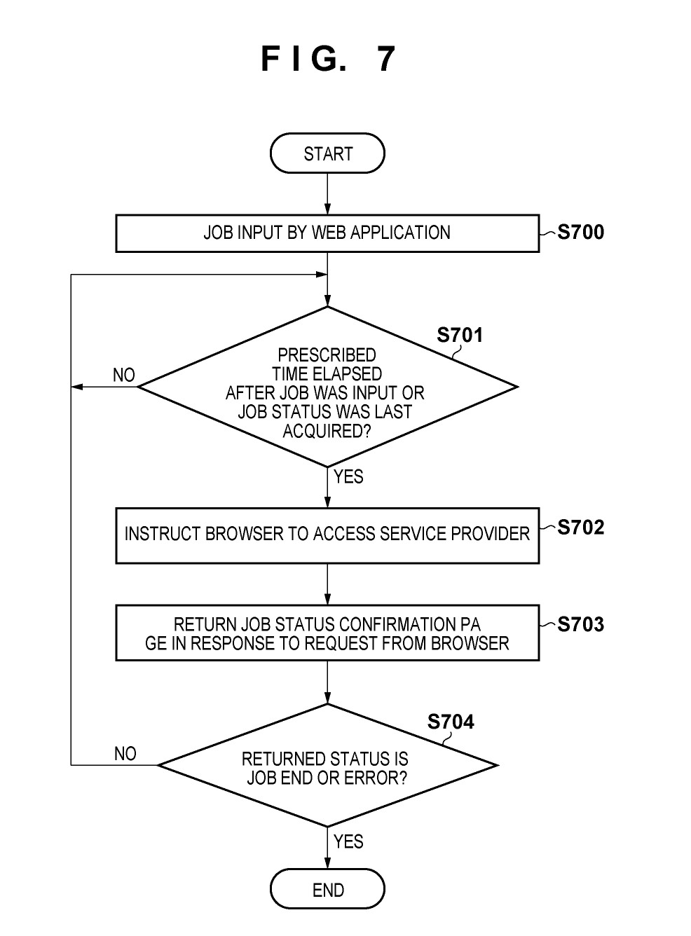

Next, a second embodiment will be described with reference to FIG. 4B and FIG. 7. With regard to configuration similar to the first embodiment, similar reference numerals will be given, and description thereof will be omitted. Firstly, the software configuration of the entire image processing system in the present embodiment will be described with reference to FIG. 4B.

In the present embodiment, a detection unit 434 is provided in the service provider 430, unlike the first embodiment. Accordingly, the detection unit 434 monitors whether the communication unit 431 is performing communication normally, and specifies the URL of content provided by the communication unit 431 to an after-mentioned URL specification reception unit 425 in the case of detecting that communication is not being performed normally. The detection unit 434 monitors whether there has not been communication from outside the service provider 430 to the communication unit 431 for a prescribed time. In the case where there has not been communication for the prescribed time, the detection unit 434 judges that communication is not being performed normally. The URL specification reception unit 425 accepts the URL of content displayed by the Web browser 420 from outside. In the case where the URL is accepted, the URL specification reception unit 425 instructs the communication unit 421 to send a request to the accepted URL.

Next, the processing procedure of the service provider 430 in the second embodiment will be described with reference to FIG. 7. Note that the processing described hereinafter is realized by the CPU 201 executing a computer program read out from the storage device 205.

In S700, the communication unit 431 of the service provider 430 accepts input of a job as the result of a request from the logic unit 412 of the Web application 410. In S701, the detection unit 434 monitors whether a prescribed time has elapsed after the job was input or after the job status was last acquired. The processing advances to S702 if the prescribed time has elapsed, and returns to S701 if the prescribed time has not elapsed.

In S702, the detection unit 434, by specify the URL of Web content provided by the communication unit 431 to the URL specification reception unit 425 of the Web browser 420, instructs that a request be sent to the communication unit 431. Any method of receiving the specification in the URL specification reception unit 425 is applicable here. For example, the URL specification reception unit 425 may accept the specification in the form of the function of a computer program, or may accept the specification via a Web service.

Next, in S703, the communication unit 431 receives a request from the communication unit 421, and returns content generated by the content generation unit 433 as a response. The content generation unit 433 generates content from the execution status of the current job. Subsequently, in S704, the service provider 430 judges whether the content returned from the communication unit 431 in response to the request from the communication unit 421 is content notifying the end of the job or content notifying that an error has occurred. Processing is ended in case of content notifying the end of the job or content notifying that an error has occurred. The processing returns to step 701 in the case of content not notifying the end of the job or the occurrence of an error.

As described above, with the image processing system in the second embodiment, the service provider 430 detects an abnormality in the network, and instructs the Web browser 420 to request content displaying the execution status of the job directly from the service provider 430. Thus, with the image processing system in the second embodiment, the user can be informed of the status of the job currently being executed even if there is an abnormality in the network.

### Third Embodiment

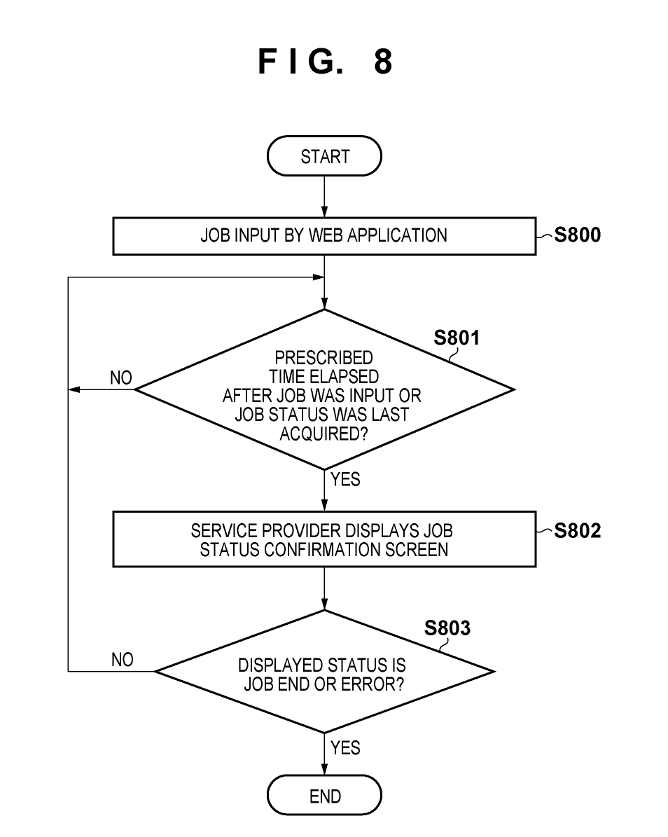

Next, a third embodiment will be described with reference to FIG. 4C and FIG. 8. With regard to configuration similar to the first and second embodiment, similar reference numerals will be given, and description thereof will be omitted. Firstly, the software configuration of the entire image processing system in the present embodiment will be described with reference to FIG. 4C.

The detection unit 434 monitors whether the communication unit 431 is performing communication normally, and instructs an after-mentioned screen display unit 435 to perform screen display in the case of detecting that communication is not being performed normally. When there is an instruction from the detection unit 434, the screen display unit 435 displays a screen on the UI display device 207 based on the execution status of the job and the state change detected by the detection unit 434.

Next, the processing procedure of the service provider 430 in the third embodiment will be described with reference to FIG. 8. Note that the processing described hereinafter is realized by the CPU 201 executing a computer program read out from the storage device 205.

Firstly, in S800, the communication unit 431 of the service provider 430 accepts input of a job as the result of a request from the logic unit 412 of the Web application 410. In S801, the detection unit 434 monitors whether a prescribed time has elapsed after the job was input or after the job status was last acquired. The processing advances to S802 if the prescribed time has elapsed, and returns to S801 if the prescribed time has not elapsed. In S802, the screen display unit 435 displays a screen conveying to the user the execution status of the job based on the execution status of the job and the state detected by the detection unit 434 at S801. The screen displayed at this time may be a screen held by the screen display unit 435 or a screen that is dynamically generated. Subsequently, in S803, the service provider 430 determines whether the execution status of the job informed to the user at S802 was error or job end. Here, the service provider 430 ends the processing if the execution status was error or job end, and returns to S801 if the execution status was not error or job end.

As described above, with the image processing system in the third embodiment, the user can be informed of the status of the job currently being executed even if an abnormality occurs in the network, as a result of the service provider 430 detecting an abnormality in the network and itself displaying a screen notifying this state.

### Other Embodiments

Aspects of the present invention can also be realized by a computer of a system or apparatus (or devices such as a CPU or MPU) that reads out and executes a program recorded on a storage device to perform the functions of the above-described embodiment(s), and by a method, the steps of which are performed by a computer of a system or apparatus by, for example, reading out and executing a program recorded on a storage device to perform the functions of the above-described embodiment(s). For this purpose, the program is provided to the computer for example via a network or from a recording medium of various types serving as the storage device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-222432 filed on Sep. 30, 2010, which is hereby incorporated by reference herein in its entirety.

What is claimed is:

1. An image processing apparatus that has a Web browser function and is connectable to a server having a Web server function, comprising:
a transmission unit that transmits a request to the server, based on a user operation input via a display screen displayed on a browser;
a determination unit that determines whether a response from the server to the request has been received normally; and
a display control unit that displays a screen on the browser in accordance with a content of the response in a case where the response has been received normally, and displays an execution status of a current job using information held by the image processing apparatus in a case where the response has not been received normally.

2. The image processing apparatus according to claim 1, comprising:
a first control unit that includes the transmission unit, the determination unit and the display control unit, and realizes the Web browser function; and
a second control unit that controls job execution performed via the Web browser function,
wherein the display control unit acquires from the second control unit and displays the execution status of the current job, in the case where the response has not been received normally.

3. The image processing apparatus according to claim 1, comprising:
a first control unit that includes the transmission unit and the display control unit, and realizes the Web browser function; and
a second control unit that includes the determination unit, and controls job execution performed via the Web browser function,
wherein the second control unit includes a notification unit that notifies the execution status of the current job to the first control unit, in the case where the response has not been received normally, and
the display control unit displays the execution status of the current job notified from the notification unit, in the case where the response has not been received normally.

4. The image processing apparatus according to claim 1, comprising:
a first control unit that includes the transmission unit, and realizes the Web browser function; and
a second control unit that includes the determination unit and the display control unit, and controls job execution performed via the Web browser function.

5. The image processing apparatus according to claim 1,
wherein the determination unit determines that the response has not been received normally, in a case where error information is received as the response or where the response is not received before a prescribed time elapses after the request is transmitted.

6. A control method of an image processing apparatus that has a Web browser function and is connectable to a server having a Web server function, comprising:
transmitting a request to the server, based on a user operation input via a display screen displayed on a browser;
determining whether a response from the server to the request has been received normally; and
displaying a screen on the browser in accordance with a content of the response in a case where the response has been received normally, and displaying an execution status of a current job using information held by the image processing apparatus in a case where the response has not been received normally.

7. A computer-readable storage medium storing a computer program for causing a computer to execute the control method of an image processing apparatus according to claim 6.
